(19) United States
(12) Patent Application Publication
(10) Pub. No.: US 2006/0017842 A1
(43) Pub. Date: Jan. 26, 2006

(54) Camera enclosure and method

(75) Inventor: Byung-moon Jun, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/186,755

(22) Filed: Jul. 22, 2005

(30) Foreign Application Priority Data
Jul. 23, 2004 (KR) 10-2004-0057585

(51) Int. Cl. H04N 5/225

(52) U.S. Cl. 348/373

(57) ABSTRACT

An enclosure accommodating a camera in which an image from a surveillance camera, rotating in a vertical direction, is not distorted and which is easily separated from and combined with the surveillance camera. The enclosure can include a cover dome having a hemispheric shell shape and a window, through which light passes, provided on a side of the cover dome, and a cover dome combining portion having a hemispheric shell shape, combined between the cover dome and an open surface, and accommodating a camera in the cover dome having the hemispheric shell shape, wherein surfaces where the cover dome and the cover dome combining portion combine with each other, are at a predetermined inclined angle.

### CROSS-REFERENCE TO RELATED APPLICATIONS

This application claims priority benefit from Korean Patent Application No. 10-2004-0057585 filed on Jul. 23, 2004 in the Korean Intellectual Property Office, the disclosure of which is incorporated herein, by reference, and in its entirety.

### BACKGROUND OF THE INVENTION

1. Field of the Invention

Embodiments of the present invention relate to a camera enclosure, and more particularly, to a camera case accommodating a camera in which an image from a surveillance camera, rotateable in a vertical direction, is not distorted and which is easily separated from and combined with the surveillance camera.

2. Description of the Related Art

In general, photographing cameras used for photographing the movements of ambient objects or people, e.g., as surveillance cameras to photograph a person's approach or behavior. Such a surveillance camera can be disposed in public places such as apartments, banks, or museums, and a variety of places, e.g., in an airtight state, to photograph ambient circumstances.

Such a conventional surveillance camera is usually attached to a ceiling, observes a photographed object, and transmits photographed video data to a predetermined place that records the photographed video data. In the meantime, the surveillance camera can generally be mounted in an enclosure, e.g., a case or housing to protect the camera from external damage and keep it in an airtight state, for example, where foreign matter, such as dust, cannot harm it.

As shown in FIG. 1, a conventional surveillance camera case 10 includes a cover dome 2, a fixing portion 3, and a window 1. The cover dome 2 can include a hemispheric shell and a portion of a cylindrical cell. The cover dome 2 can be combined with the fixing portion 3 fixed to the ceiling. A surveillance camera and accessories thereof are accommodated in the cover dome 2 and the fixing portion 3, with the window 1 being placed on a side of the cover dome 2 allowing light to pass through, in a vertical direction.

As shown in FIG. 2, the surveillance camera case 10 can be rotated around the circumference in a horizontal direction, and a camera 4 in the cover dome 2 can be rotated through 90 degrees in a vertical direction. As a result, the camera 4 can photograph an object in all directions under the ceiling.

However, in the conventional surveillance camera case 10, an inflection line 5, a variation of the curvature where the hemispheric shell combines with the cylindrical shell, exists in the cover dome 2. As such, the window 1 also has the inflection line 5. Thus, when light passes through the inflection line 5 on the window 1 and is transferred to the camera 4, the image becomes distorted, due to the inflection line 5, such that the surveillance camera cannot operate as intended. For this reason, in actuality, the conventional surveillance camera case 10 is not designed to be rotated through 90 degrees in a vertical direction, but rather, is designed to be rotated only through approximately 70 degrees or more.

In order to solve this problem, as shown in FIG. 3, a predetermined offset may be created between a central position of a vertical radius of the cover dome 2 and a central position of a rotational radius of the camera 4, so that the inflection line does not exist in the light path, even though the camera 4 is placed in a horizontal direction, i.e., rotated to 90 degrees. In this way, it is possible to prevent image distortion from occurring when light passes through the inflection line.

According to this method, however, the radius of the cover dome 2 needs to be considerably larger than the rotational radius of the camera 4 to create the predetermined offset between a central position of a vertical radius of the cover dome 2 and a central position of a rotational radius of the camera. This means that the cover dome 2 becomes considerably bulky, which runs counter to recent industrial trends towards lighter weights and small sizes and results in increased costs for surveillance camera cases as the size of the cover dome 2 increases.

Accordingly, it would be desirable to have a method and enclosure preventing distortion of an image input to a camera lens while the vertical rotational angle is at 90 degrees, or more, without increasing the radius of the cover dome 2.

### SUMMARY OF THE INVENTION

Embodiments of the present invention set forth a surveillance camera enclosure and method in which a change of curvature does not occur at a portion onto which light is incident.

Embodiments of the present invention also set forth a surveillance camera enclosure in which a camera can be rotated through 90 degrees, or more, in a vertical direction.

To achieve the above and/or other aspects and advantages, embodiments of the present invention set forth an enclosure for a surveillance camera, the enclosure including a cover shell comprising a window provided on a side of the cover shell, and a cover combining portion combinable with the cover shell and accommodating a camera, observing through the window of the cover shell, wherein the cover shell and the cover combining portion combine with each other along a predetermined inclined angle relative to a horizontal orientation of the camera.

The cover shell may be a dome having a hemispheric shape. The cover combining portion may also be a dome having a hemispheric shape.

The inclined angle may be 45 degrees.

The camera may be fixed in a camera supporting portion, with a rotational shaft being placed on a side of the camera supporting portion, a moving shaft being placed on an alternate side of the camera supporting portion and separated from the rotational shaft by a predetermined offset, a first fixing plate accommodating the moving shaft being placed on an internal side of the cover combining portion, and a second fixing plate accommodating the rotational shaft being placed on the alternate side of the cover combining portion.

In addition, the camera supporting portion may include an attached CCD board, and connecting lines connected to the CCD board extend via a hole formed in a center of a fixing portion, supporting the cover combining portion and accommodated to be fixed to a surface, and to be connected to an external device. The first fixing plate may include a guide slot, with the guide slot being formed as a hole shaped of an arc having a predetermined angular width to enable the moving shaft to move along the arc shaped hole when the rotational shaft is rotated and to disable the rotational shaft to rotate by more than the angular width.

The arc shaped hole may be formed in the first fixing plate and has an arc of at least 90 degrees. The second fixing plate may also include a hole accommodating the rotational shaft, and an end of the rotational shaft may have a tapered shape.

The enclosure may include a fixing portion supporting the cover combining portion and accommodated to be fixed to a surface, wherein the cover combining portion is rotatable 180 degrees clockwise along an edge contacting the fixing portion and rotatable 180 degrees counterclockwise along the edge contacting the fixing portion. The surface may be a ceiling.

An insertion frame, having an outer diameter which corresponds to approximately a size of an inner diameter of the cover combining portion, can be placed on an end of an opened surface of the cover shell, and an insertion protrusion is placed in a predetermined position of the insertion frame such that when the cover shell is combined with the cover combining portion, the insertion protrusion is inserted into an insertion slot formed inside an end of the opened surface of the cover combining portion, and such that when the cover dome is rotated the insertion protrusion inserts into a fixing slot formed inside the end of the opened surface of the cover combining portion, thereby securely combining the cover shell and the cover combining portion.

To achieve the above and/or other aspects and advantages, embodiments of the present invention set forth a camera surveillance method, the method including traversing a camera, to observe through a window of a cover shell of an enclosure, through a beginning and ending of a rotational arc, and enclosing the camera with a combining of the cover shell and a cover combining portion, wherein the cover shell and the cover combining portion combine with each other along a predetermined inclined angle relative to a horizontal orientation of the camera.

Here, the inclined angle may be 45 degrees, the rotational arc may be an arc of at least 90 degrees. The rotational arc may also be an arc greater than 90 degrees.

The cover combining portion may be attachable to a surface to support the enclosure, and the method may include rotating the enclosure, wherein the cover combining portion is attachable to the surface for the rotating of the enclosure.

To achieve the above and/or other aspects and advantages, embodiments of the present invention set forth a camera surveillance method, the method including traversing a camera, to observe through a window of a cover shell of an enclosure, through a beginning and ending of a rotational arc, and communicating with the camera through a hole of the enclosure, enclosing the camera with a combining of the cover shell and a cover combining portion, wherein the cover shell and the cover combining portion combine with each other along a predetermined inclined angle relative to a horizontal orientation of the camera.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional surveillance camera case;

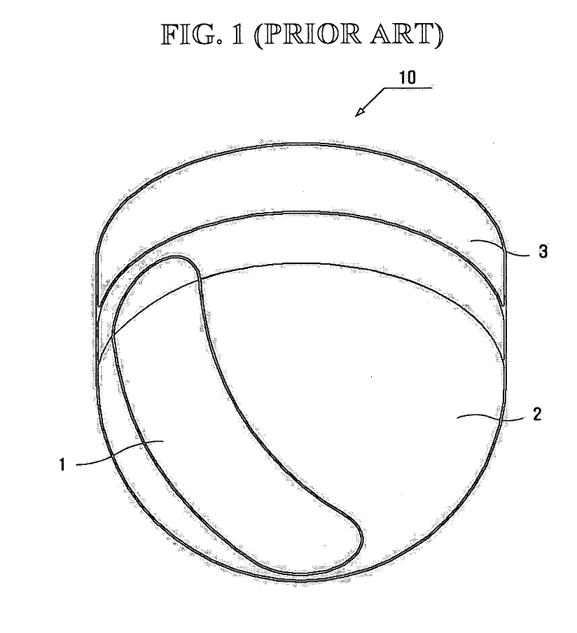

FIG. 2 illustrates the range of movement of a camera in the surveillance camera case shown in FIG. 1;

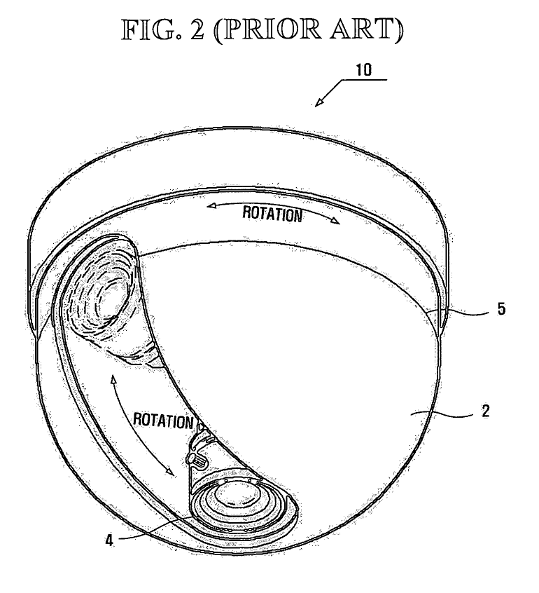

FIG. 3 illustrates a structure of another conventional surveillance camera case;

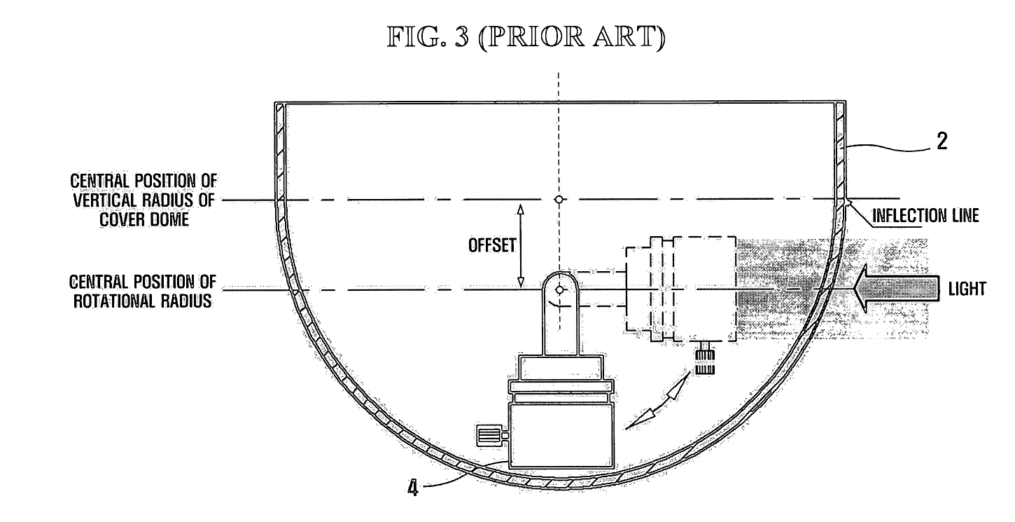

FIG. 4 illustrates a surveillance camera case, according to an embodiment of the present invention;

FIG. 5 is a side view of the surveillance camera case shown in FIG. 4, according to an embodiment of the present invention;

FIG. 6 illustrates the range of movement of a surveillance camera in the camera case shown in FIG. 4, according to an embodiment of the present invention;

FIG. 7 illustrates an installation structure of a surveillance camera in a cover dome combining portion, according to an embodiment of the present invention;

FIG. 8 illustrates the installation structure of FIG. 7 from an alternate direction;

FIG. 9 illustrates the surveillance camera case of FIG. 4, showing a moving shaft of the camera case, according to an embodiment of the present invention;

FIG. 10 is a vertical cross-sectional view of the camera case shown in FIG. 4;

FIG. 11 is another vertical cross-sectional view of the camera case shown in FIG. 4; and

FIG. 12 illustrates a cover dome and a cover dome combining portion enabled to be securely combined with each other, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described below to explain the present invention by referring to the figures.

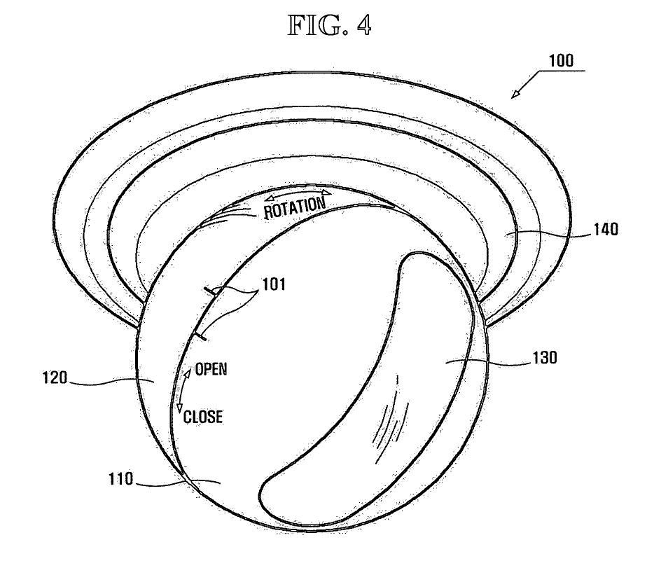

FIG. 4 illustrates a surveillance camera case 100, according to an embodiment of the present invention. The surveillance camera case 100 can include a cover dome 110, a cover dome combining portion 120, a window 130, and a fixing portion 140. The cover dome 110 has a hemispheric shell shape and can be combined with the cover dome combining portion 120 at an inclination of 45 degrees, for example, in a horizontal or vertical direction. The window 130, with high transparency, can be placed on a side of the cover dome 110 so that a camera can photograph an image at a predetermined angle in a vertical direction. The window 130 may also be combined with and separated from the cover dome 110.

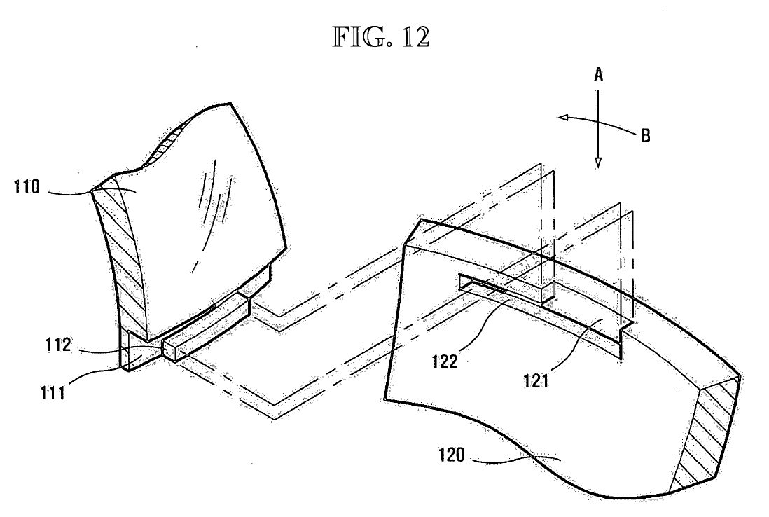

The cover dome combining portion 120 can have a hemispheric shell shape and can be combined with the cover dome 110 at an inclination of 45 degrees, for example. There may be several combining methods but an example thereof will be described below with reference to FIG. 12. When the cover dome 110 and the cover dome combining portion 120 are combined with each other, and then rotated around a predetermined angle in a predetermined direction (a closed direction of FIG. 4), the cover dome 110 may be fixed to the cover dome combining portion 120 and thus is not easily separated from the cover dome combining portion 120. In order to indicate this combined position, a marking 101 can be indicated on the cover dome 110 and the cover dome combining portion 120 in order to indicate the relative positions of the cover dome 110 and the cover dome combining portion 120. For example, when the two markings lay opposite to each other, the cover dome 110 and the cover dome combining portion 120 are in an opened state.

In addition, the cover dome combining portion 120 is combined with the fixing portion 140 and is rotated in a horizontal direction. The entire angle through which the cover dome combining portion 120 may be rotated can be 360 degrees. However, when the cover dome combining portion 120 is rotated through 360° only in one direction, internal connection lines may twist and cause the camera trouble. Thus, as an example, the cover dome combining portion 120 may be limited to a rotation of 180 degrees clockwise and 180 degrees counterclockwise.

The fixing portion 140 can be fixed to a ceiling, for example, and support the cover dome combining portion 120. A hole may also be formed in the center of the fixing portion 140, with internal connecting lines passing through the ceiling via the hole.

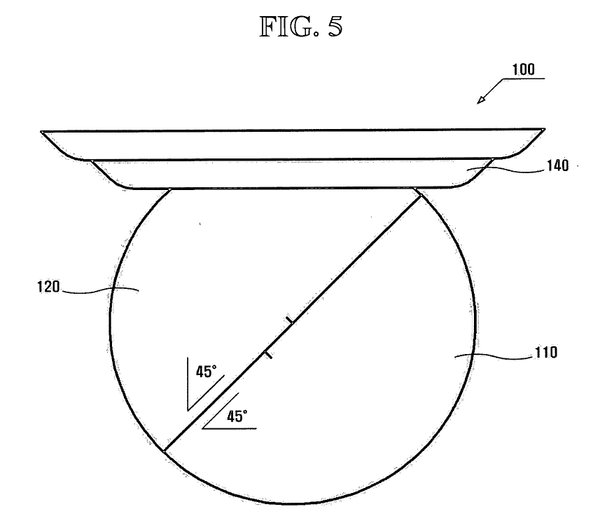

FIG. 5 is a side view of the surveillance camera case 100. As shown in FIG. 5, a joint formed by the hemispheric cover dome 110 and the hemispheric cover dome combining portion 120 can be inclined, e.g., at approximately 45 degrees in a vertical direction or a horizontal direction. Since the cover dome combining portion 120 is suspended by the fixing portion 140, the fixing portion 140 is securely fixed to the ceiling so as to support the entire case 100.

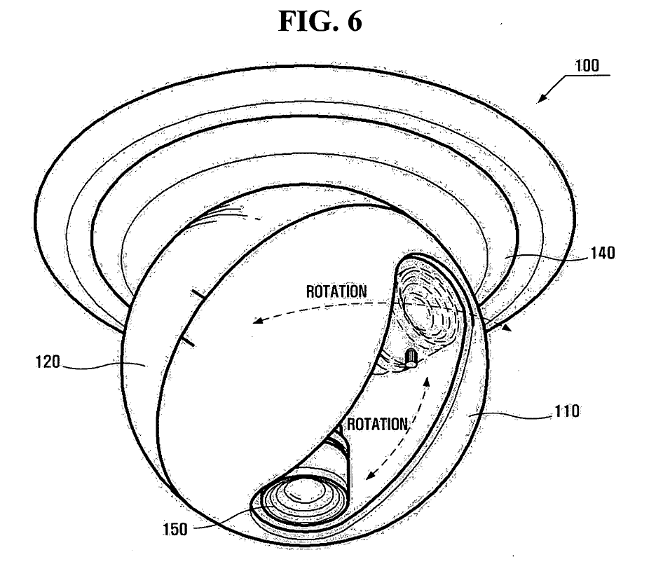

FIG. 6 illustrates the range of movement of the surveillance camera in the camera case 100. Since the cover dome combining portion 120, based on the fixing portion 140, may be rotated through 360 degrees in a horizontal direction and a surveillance camera 150 may be rotated through 90 degrees in a vertical direction, the surveillance camera 150 can photograph all objects below the ceiling. In some special circumstances, the surveillance camera 150 may be rotated more than 90 degrees in a vertical direction.

For example, in the case of a surveillance camera installed on the ceiling above stairs, in order to photograph an upper portion of the stairs, the surveillance camera could be rotated through 90 degrees, or more, in a vertical direction, based on the angle of a vertical downward direction being 0 degrees. The surveillance camera 150 can be rotated up to 135 degrees from the vertical downward position, for example. However, taking into account the size of a camera lens and so on, the angle through which the surveillance camera 150 may view may be reduced to approximately 110 degrees in a vertical direction, that is, the effective rotation angle of the cover dome 110 may become approximately 110 degrees. Thus, the use of the camera case, according to an embodiment of the present invention, enables photographing of an object positioned above a horizontal line.

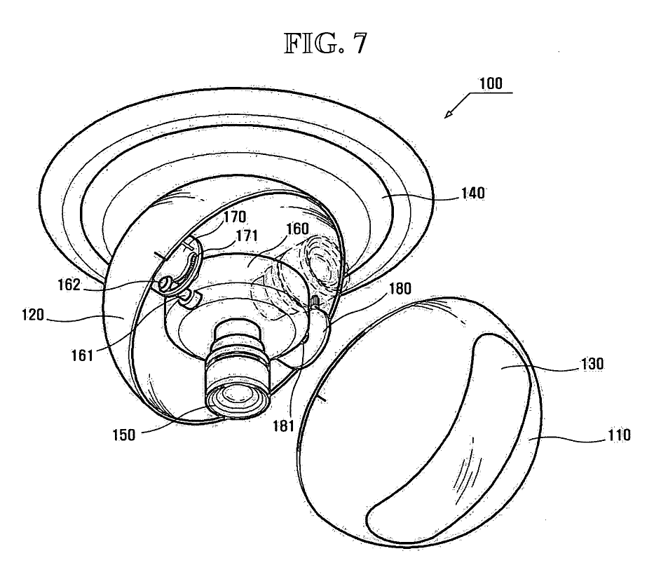

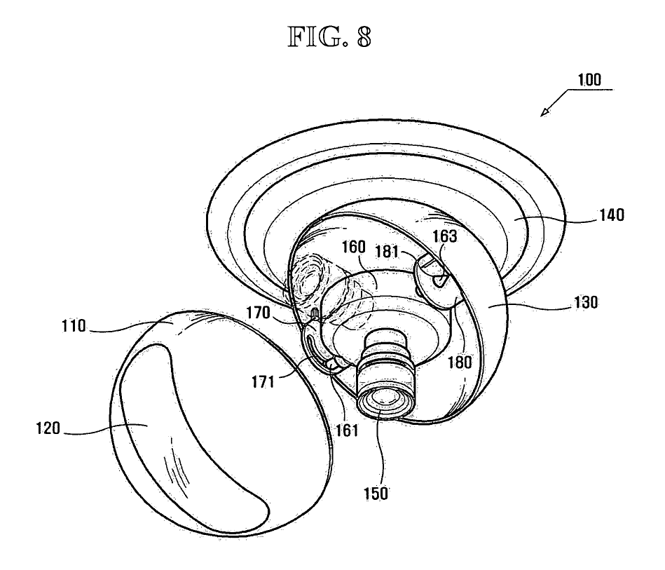

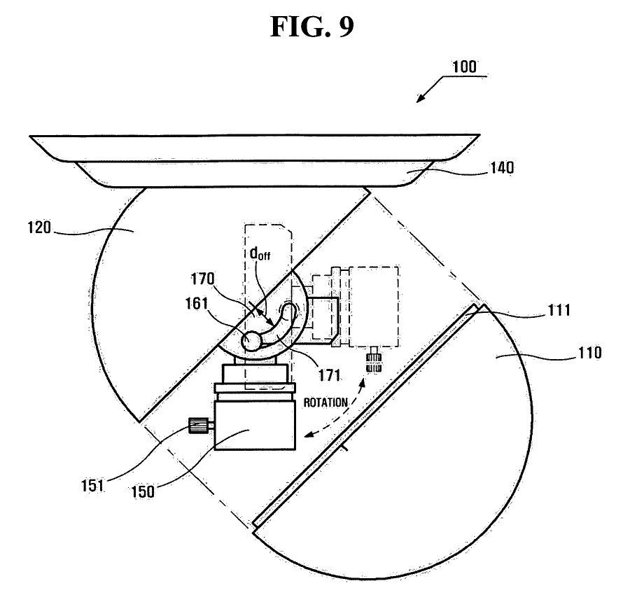

FIG. 7 illustrates an installation structure of the surveillance camera 150 in the cover dome combining portion 120. The surveillance camera 150 can be combined with a camera supporting portion 160, with a moving shaft 161 and a rotational shaft (163 of FIG. 8) being disposed on both sides of the camera supporting portion 160. The rotational shaft 163 may be inserted into a hole 181 formed in a second fixing plate 180 and can be rotated in the hole 181. The moving shaft 161 may be disposed on a side opposite to the rotational shaft 163 of the camera supporting portion 160. When the rotational shaft 163 is rotated by an amount corresponding to a predetermined offset (doff of FIG. 9), the moving shaft 161 can be disposed to move through the length of the predetermined arc.

The moving shaft 161 can be inserted into a guide slot 171, formed in a first fixing plate 170, and a fixing screw 162 can be placed on an end of the moving shaft 161 such that the moving shaft 161 is prevented from being detached from the guide slot 171. The guide slot 171 can be formed in an arc shape, for example, with a predetermined angular width so that the moving shaft 161 moves along an arc, with the rotational shaft 163 not being rotated beyond the predetermined angle when the rotational shaft 163 is rotated. The guide slot 171 can be designed to have an arc shape, according to a predetermined rotation angle of the rotational shaft 163, for example, 90 degrees, based on the diameter of the moving shaft 161.

FIG. 8 illustrates the installation structure of FIG. 7 from an alternate direction. The end of the rotational shaft 163 can have a tapered shape, for example, a conic shape, so it can be easily inserted into the hole 181 of the second fixing plate 180. The rotational shaft 163 may then freely rotate in the hole 181. However, the moving shaft 161, which is in a direction opposite to the rotational shaft 163, may move through the length of the arc. As a result, a rotational angle of the rotational shaft 163 is limited to the angular width of the arc of the guide slot 171.

FIG. 9 illustrates the surveillance camera case of FIG. 4, showing the moving shaft 161 of the camera case 100, according to an embodiment of the present invention. A direction of a lens of the camera 150 may be any of the directions between or including the horizontal direction (90 degrees) and the vertical downward direction depending on the amount of rotation of the rotational shaft 163. As such, the camera 150 can photograph objects in various directions. If necessary, the cover dome 110 may also be removed from the camera case 100, and then an adjusting pin 151 may be adjusted so that fine adjustments for camera photographing such as diaphragm adjustment and focus adjustment can be performed, for example. The cover dome 110 can have an insertion frame 111 with an outer diameter that is smaller than the inner diameter of the cover dome combining portion 120, so it can be easily combined with and separated from the cover dome combining portion 120. The cover dome 110 can also have an insertion protrusion (112 of FIG. 12) placed in a predetermined position of the insertion frame 111.

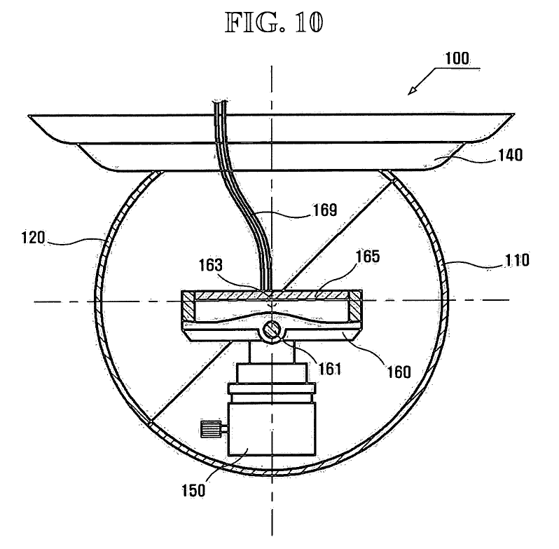

FIG. 10 is a vertical cross-sectional view of the camera case 100. As shown in FIG. 10, the camera supporting portion 160 can include a central shaft 163 and a rotational shaft 161, which is in a direction opposite to the central shaft 163 and separate from the central shaft 163. The camera supporting portion 160 may also include a charge coupled device (CCD) board 165 which controls the camera 150 and processes an image captured by the camera 150. The CCD board 165 may then transmit the processed image using power supplied via connecting lines 169, with the connecting lines 169 passing through the ceiling via a central hole and connecting to an external device, for example.

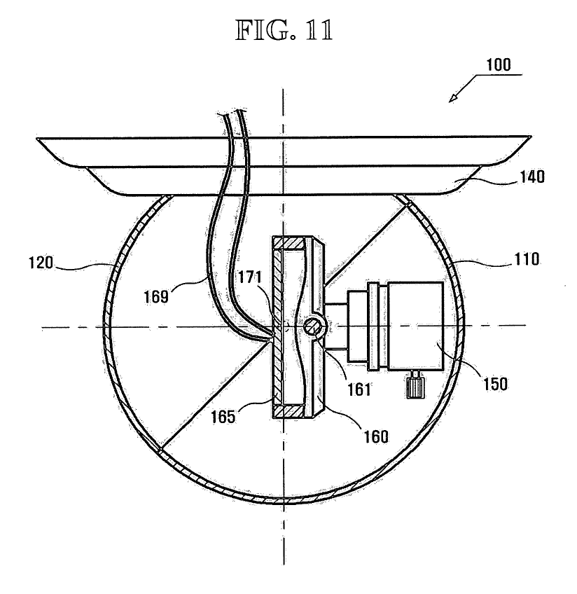

As shown in FIG. 11, the length of the connecting lines 169 may be constant so that tension is not applied to the connecting lines 169 even wihile the camera 150 is rotated through a predetermined angle.

As noted above, FIG. 12 illustrates a structure enabling the cover dome 110 and the cover dome combining portion 120 to be securely combined with each other. The insertion frame 111 is placed on an end of an opened surface of the cover dome 110, with the insertion protrusions 112 being placed in predetermined positions (for example, in positions that are spaced 90 degrees apart along the insertion frame 111) of the insertion frame 111. When combining the cover dome 110 and the cover dome combining portion 120 with each other, the insertion frame 111 of the cover dome 110 can be inserted into the cover dome combining portion 120, in the direction of arrow A, by referring to the markings (101 of FIG. 4) on both the cover dome 110 and the cover dome combining portion 120. In this case, the insertion protrusion 112 can be inserted into an insertion slot 121 of the cover dome combining portion 120. After that, when the cover dome 110 is rotated, in the direction of arrow B, for example, the insertion protrusion 112 can be inserted into a fixing slot 122 so that the cover dome 110 is joined to the cover dome combining portion 120.

When the cover dome 110 and the cover dome combining portion 120 are separated from each other, the cover dome 110 may be rotated in a direction opposite to the direction of arrow B and then pulled in a direction opposite to the direction of arrow A, such that the cover dome 110 is easily separated from the cover dome combining portion 120.

As described above, in a surveillance camera enclosure, according to embodiments of the present invention, distortion of an image input to a surveillance camera can be prevented.

In addition, a camera can be rotated through 90 degrees, or more, in a vertical direction such that in some special circumstances, an image positioned above the horizontal line can be photographed.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An enclosure for a surveillance camera, the enclosure comprising:
a cover shell comprising a window provided on a side of the cover shell; and
a cover combining portion combinable with the cover shell and accommodating a camera, observing through the window of the cover shell,
wherein the cover shell and the cover combining portion combine with each other along a predetermined inclined angle relative to a horizontal orientation of the camera.

2. The enclosure of claim 1, wherein cover shell is a dome having a hemispheric shape.

3. The enclosure of claim 1, wherein the cover combining portion is a dome having a hemispheric shape.

4. The enclosure of claim 1, wherein the inclined angle is 45 degrees.

5. The enclosure of claim 1, wherein the camera is fixed in a camera supporting portion, with a rotational shaft being placed on a side of the camera supporting portion, a moving shaft being placed on an alternate side of the camera supporting portion and separated from the rotational shaft by a predetermined offset, a first fixing plate accommodating the moving shaft being placed on an internal side of the cover combining portion, and a second fixing plate accommodating the rotational shaft being placed on the alternate side of the cover combining portion.

6. The enclosure of claim 5, wherein the camera supporting portion comprises an attached CCD board, and connecting lines connected to the CCD board extend via a hole formed in a center of a fixing portion, supporting the cover combining portion and accommodated to be fixed to a surface, and to be connected to an external device.

7. The enclosure of claim 5, wherein the first fixing plate comprises a guide slot, with the guide slot being formed as a hole shaped of an arc having a predetermined angular width to enable the moving shaft to move along the arc shaped hole when the rotational shaft is rotated and to disable the rotational shaft to rotate by more than the angular width.

8. The enclosure of claim 7, wherein the arc shaped hole is formed in the first fixing plate and has an arc of at least 90 degrees.

9. The enclosure of claim 7, wherein the second fixing plate comprises a hole accommodating the rotational shaft.

10. The enclosure of claim 7, wherein an end of the rotational shaft has a tapered shape.

11. The enclosure of claim 1, further comprising a fixing portion supporting the cover combining portion and accommodated to be fixed to a surface, wherein the cover combining portion is rotatable 180 degrees clockwise along an edge contacting the fixing portion and rotatable 180 degrees counterclockwise along the edge contacting the fixing portion.

12. The enclosure of claim 11, wherein the surface is a ceiling.

13. The enclosure of claim 1, wherein an insertion frame, having an outer diameter which corresponds to approximately a size of an inner diameter of the cover combining portion, is placed on an end of an opened surface of the cover shell, and an insertion protrusion is placed in a predetermined position of the insertion frame such that when the cover shell is combined with the cover combining portion, the insertion protrusion is inserted into an insertion slot formed inside an end of the opened surface of the cover combining portion, and such that when the cover dome is rotated the insertion protrusion inserts into a fixing slot formed inside the end of the opened surface of the cover combining portion, thereby securely combining the cover shell and the cover combining portion.

14. A camera surveillance method, the method comprising:
traversing a camera, to observe through a window of a cover shell of an enclosure, through a beginning and ending of a rotational arc; and
enclosing the camera with a combining of the cover shell and a cover combining portion, wherein the cover shell and the cover combining portion combine with each other along a predetermined inclined angle relative to a horizontal orientation of the camera.

15. The method of claim 14, wherein the inclined angle is 45 degrees.

16. The method of claim 14, wherein the rotational arc is an arc of at least 90 degrees.

17. The method of claim 14, wherein the rotational arc is an arc greater than 90 degrees.

18. The method of claim 14, wherein the cover combining portion is attachable to a surface to support the enclosure.

19. The method of claim 18, further comprising rotating the enclosure, wherein the cover combining portion is attachable to the surface for the rotating of the enclosure.

20. A camera surveillance method, the method comprising:
traversing a camera, to observe through a window of a cover shell of an enclosure, through a beginning and ending of a rotational arc; and
communicating with the camera through a hole of the enclosure, enclosing the camera with a combining of the cover shell and a cover combining portion, wherein the cover shell and the cover combining portion combine with each other along a predetermined inclined angle relative to a horizontal orientation of the camera.
